(19) United States
(12) Patent Application Publication
(10) Pub. No.: US 2019/0010892 A1
(43) Pub. Date: Jan. 10, 2019

(54) PISTON WITH A COOLING CHANNEL INSERT

(71) Applicant: MAHLE International GmbH, Stuttgart (DE)

(72) Inventor: Michael LAPP, Farmington Hills, MI (US)

(73) Assignee: MAHLE International GmbH, Stuttgart (DE)

(21) Appl. No.: 15/644,965

(22) Filed: Jul. 10, 2017

(51) Int. Cl. F02F 3/22; F02F 3/00

(52) U.S. Cl. CPC F02F 3/22; F02F 2200/00; F02F 2003/0061; F02F 3/003

(57) ABSTRACT

A piston for an internal combustion engine has a lower piston part and an upper piston part connected with the lower piston part by welding to form jointly a circumferential cooling channel having inner and outer circumferential walls. The welding process forms weld seams that curl outwards on the inner and outer circumferential walls. An insert is disposed in the circumferential cooling channel. The insert is placed in the cooling channel prior to welding of the upper and lower piston parts, and is clamped in place by at least one of the weld seams that projects into the cooling channel. This way, no additional fabrication or steps need to be taken to hold the insert securely in place in the cooling channel.

### BACKGROUND OF THE INVENTION

### 1. Field of the Invention

The present invention relates to a piston for an internal combustion engine having a closed cooling channel surrounding the combustion chamber. In particular, the invention relates to a piston having an insert disposed in the cooling gallery. The insert is placed in the gallery prior to welding of the two piston parts together, and is held in place by the resulting welding curls.

### 2. The Prior Art

It is known to place inserts into a cooling gallery to help direct the flow of cooling oil or to act as a heat sink to improve heat transfer within the piston. These inserts need to be held in place in the cooling gallery, generally by mechanical means such as bolts or screws or by tension.

U.S. Pat. No. 9,228,480 to Wirkkala II et al. discloses a piston having an insert in the cooling gallery. The insert is placed in an open cooling gallery that is closed by a closure element.

US Patent Application Publication No. 2016/0222912A1 to Ni discloses a piston having an insert in the cooling gallery. This insert is in the form of a ring and is held in the top of the cooling gallery by the ring applying tension on the inner wall of the cooling gallery.

It would be desirable to construct an insert that can take on many different forms, be able to be used in a completely closed cooling gallery, and which is held securely in place without any additional steps or materials.

### SUMMARY OF THE INVENTION

This invention is accomplished by a piston for an internal combustion engine having a lower piston part and an upper piston part connected with the lower piston part by welding to form jointly a circumferential cooling channel having inner and outer circumferential walls. The welding process forms weld seams that curl outwards on the inner and outer circumferential walls.

An insert is disposed in the circumferential cooling channel. The insert is placed in the cooling channel prior to welding of the upper and lower piston parts, and is clamped in place by at least one of the weld seams that projects into the cooling channel. This way, no additional fabrication or steps need to be taken to hold the insert securely in place in the cooling channel.

The insert preferably extends around the entire circumference of the cooling channel, and can take on various different geometries throughout its circumference. This way the insert can be constructed to have maximum impact on the thermal regulation of the piston. The insert can be formed of aluminum, or any other suitable material that has a higher thermal coefficient that the piston material.

In one embodiment, the insert is held in place by the inner weld seam. The insert sits on the bottom of the cooling channel, and the projection of the weld seam into the cooling channel prevents any axial movement of the insert. The weld seams of the piston can be radially offset from each other, so that the weld seam on the outer wall of the cooling channel is located higher than the weld seam on the inner wall of the cooling channel.

The various geometries of the insert can be constructed based on the different cooling needs around the circumference of the piston. In one embodiment, at least part of the insert can have an L-shaped cross-section. The vertical part of the L abuts the outer wall of the cooling channel, while the horizontal part of the L is fixed underneath the weld seam of the inner wall of the cooling channel. This geometry allows the insert to operate as a heat sink with improved heat transfer from the piston to the cooling oil in the cooling channel, and also optimizes the required shaker volume of the cooling channel.

In another embodiment, or in another part of the same insert, the insert can be constructed with at least one vertical bore running therethrough, to form a standpipe construction. The insert in this area still has a horizontal section that can be clamped by the weld seam.

In another embodiment, the insert has a substantially semicircular channel formed on a top surface thereof. This scooped out configuration directs the cooling oil toward the top of the cooling channel for improved cooling of the piston during operation. This geometry can be located all the way around the insert, or can be combined with other geometries such as discussed above and below. In yet another embodiment, the insert has at least one oil ramp extending upwards into the cooling channel. This oil ramp extends diagonally across as well, and serves to direct the oil into the cooling channel for further improved cooling of the patent.

The invention also relates to a method for manufacturing the piston described above.

In the method, an upper piston part and a lower piston part are formed separately, either by casting or forging. The upper piston part has a piston crown, an outer circumferential wall and an inner circumferential wall, which both extend downwardly from the piston crown. The lower piston part comprises the pin bosses and skirt, as well as upwardly extending inner and outer circumferential walls. A ring carrier with several ring grooves can be formed in the outer circumferential walls of both the upper and lower piston parts. While the parts are separate, the insert is placed into the cooling gallery bottom between the inner and outer circumferential walls of the lower piston part.

Thereafter, the outer and inner circumferential walls of the upper piston part are connected to the outer and inner circumferential walls of the lower piston part by welding, with the formation of weld beads at weld seams and the formation of a closed circumferential cooling gallery with the insert disposed therein.

The insert is held in place by at least one of the weld beads as the bead is formed over the edge of the insert, and holds it in place against any axial motion. The insert preferably extends around the entire circumference of the piston.

Preferably, the upper and lower piston parts are connected by friction welding. However, other methods could also be used.

After welding, the piston can be finished the piston by machining the ring grooves and other features that are not already formed during the casting or forging processes.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a cross-sectional view of the piston according to the invention prior to welding of the two piston parts, and with an insert placed in the cooling channel.

FIG. 2 shows a cross-sectional view of a finished piston according to the invention having an insert in the cooling channel, with two different cross-sections; and

FIG. 3 shows another cross-sectional view of a finished piston according to the invention having an insert with two different cross-sections.

### DETAILED DESCRIPTION OF THE PREFERRED EMBODIMENT

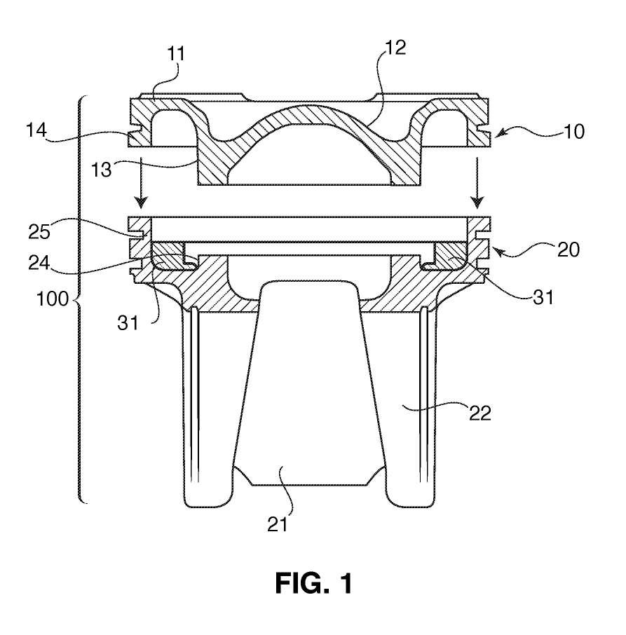

Referring now in detail to the drawings, FIG. 1 shows a piston 100 according to the invention. Piston 10 consists of an upper part 10 and a lower part 20. Upper part 10 has the piston crown 11 with a combustion bowl 12, an inner circumferential wall 13 and an outer circumferential wall 14. The upper part of a cooling channel 30 is formed between inner circumferential wall 13 and outer circumferential wall 14.

Piston lower part 20 consists of a skirt 21, a pin boss 22, and an inner circumferential wall 24 and an outer circumferential wall 25. The lower part of cooling channel 30 is formed between inner circumferential wall 24 and outer circumferential wall 25. An insert 31 is placed in the lower part of cooling channel 30 in lower piston part 20. Insert 31 extends entirely around the circumference of piston 100 and is formed of a material that has a higher thermal coefficient than that of the piston itself. For example, if the piston is made of iron or steel, the insert may be made of aluminum.

Once insert 31 is placed into lower piston part 20, the upper and lower piston parts are welded together using any suitable welding method, such as friction welding.

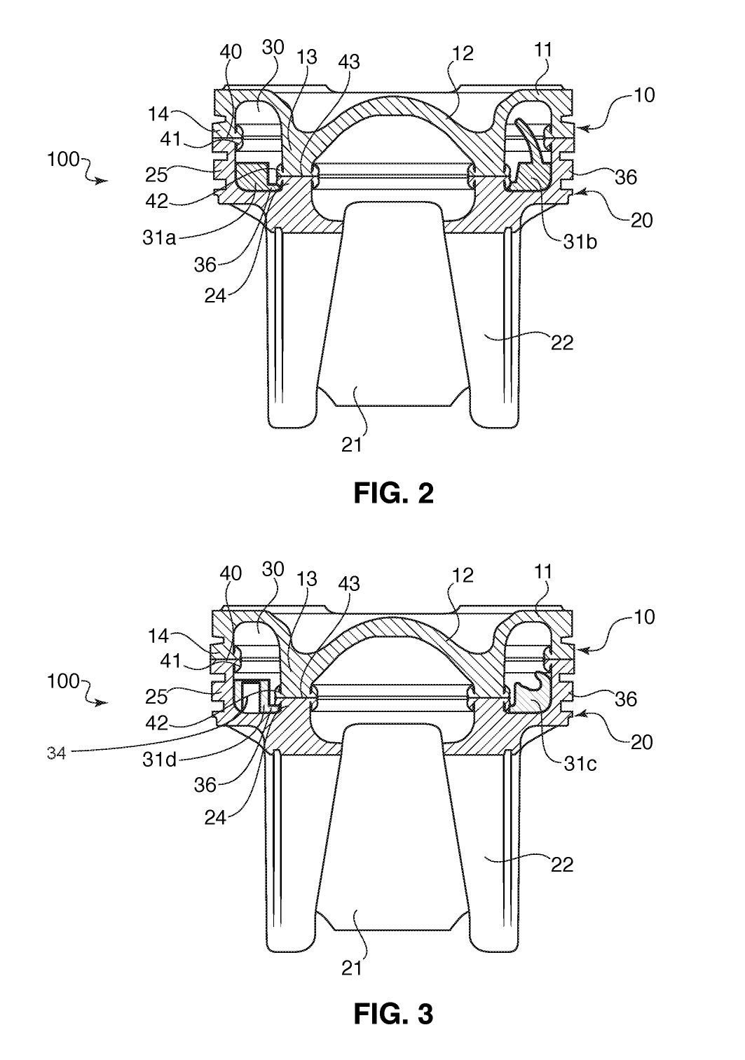

The fully welded piston 100 is shown in FIGS. 2 and 3. Once welded, the finished piston 100 contains a closed circumferential cooling channel 30 and after finish machining, a ring carrier 36. FIGS. 2 and 3 show the piston 100 according to the invention with four different insert shapes 31a, 31b, 31c and 31d. The inserts 31 can have the same shape throughout the entire circumference of the insert, or the shape can change across the circumference. The shapes shown here do not necessarily have to be combined in the manner shown, but can be used alone or in any combination with the other shapes shown.

During the welding process, weld beads 41 are formed at the weld seams 40 between the outer circumferential walls 14, 25 and weld beads 42 are formed at the weld seam 43 between the inner circumferential walls 13, 24. As can be seen in FIGS. 2 and 3, weld bead 42 is formed directly on top of the inner portion of inserts 31 and essentially clamps them in place within the cooling channel 30, so that any axial motion of the insert 31 is prevented.

By this process, no additional methods or devices are required to secure the insert within the cooling channel. The present invention provides a simple an inexpensive way to provide a piston with a cooling channel insert that is securely held within the cooling channel.

The insert 31 can take on various geometries 31a, 31b, 31c and 31d, as shown in FIGS. 2 and 3. In geometry 31a, the insert can take on a basic sheet metal structure that forms a heat sink within the cooling channel 30. The size of the insert can be structured to optimize the shaker volume within the cooling channel.

Geometry 31b includes an oil ramp 32 that extends upwards from the insert 31. This oil ramp can direct the cooling oil to desired parts of the cooling channel to optimize heat transfer. Geometry 31c includes an integrated shield 33 in the form of a scoop, which also serves to direct the cooling oil in such a way so as to maximize heat transfer. In geometry 31d, a standpipe structure is shown, with a bore 34 through the insert 31. In this geometry, the insert usually has two bores located on opposite sides of the piston. The oil can drain through the bores. In each of the geometries of insert 31, the insert has a lip 36 that extends underneath the weld bead 42 and is clamped in place by weld bead 42. In this embodiment, the weld seams 40 and 43 are located vertically offset from each other, with weld seam 43 being located closer to the bottom of the cooling channel 30. However, the piston could be constructed with any arrangement of the weld seams, as long as one of the weld beads is located so as to clamp the insert in place after welding. For example, in an alternative arrangement, outer weld bead 41 can clamp the insert 31 in place.

Accordingly, while only a few embodiments of the present invention have been shown and described, it is obvious that many changes and modifications may be made thereunto without departing from the spirit and scope of the invention.

What is claimed is:

1. A piston for an internal combustion engine, comprising:
a lower piston part; and
an upper piston part connected with the lower piston part by welding to form jointly a circumferential cooling channel having inner and outer circumferential walls, said upper piston part having a circumferential ring belt provided with ring grooves, wherein the inner circumferential wall has an inner weld seam and the outer circumferential wall has an outer weld seam, each of the weld seams having weld beads protruding therefrom; and
an insert disposed in the circumferential cooling channel, said insert being placed in the cooling channel prior to welding of the upper and lower piston parts, and being held in place by at least one of the weld beads.

2. The piston according to claim 1, wherein the insert is formed of aluminum.

3. The piston according to claim 1, wherein the insert extends around a full circumference of the cooling channel.

4. The piston according to claim 1, wherein the insert is held in place by the inner weld seam.

5. The piston according to claim 1, wherein the insert has an L-shaped cross-section.

6. The piston according to claim 1, wherein the insert is configured with at least one vertical bore running therethrough.

7. The piston according to claim 1, wherein the insert has a channel formed on a top surface thereof.

8. The piston according to claim 1, wherein the insert has at least one oil ramp extending upwards into the cooling channel.

9. The piston according to claim 1, wherein the a shape of the cross-section of the insert varies throughout a circumference of the insert.

10. A method for manufacturing a piston, comprising:
forming an upper piston part having a piston crown, an outer circumferential wall and an inner circumferential wall;
forming a lower piston part having a skirt and pin bosses, an outer circumferential wall and an inner circumferential wall and a cooling channel bottom between the outer circumferential wall and inner circumferential wall;
placing an insert into the cooling channel bottom;
thereafter connecting the outer and inner circumferential walls of the upper piston part to the outer and inner circumferential walls of the lower piston part by welding, with the formation of weld beads at weld seams and the formation of a closed circumferential cooling channel with the insert disposed therein;
wherein the insert is held in place by at least one of the weld beads.

11. The method according to claim 10, wherein the upper and lower piston parts are connected by friction welding.

12. The method according to claim 10, further comprising finishing the piston by machining after the step of connecting.

13. The method according to claim 10, wherein the insert extends around a full circumference of the cooling channel.
